(19) United States
(12) Patent Application Publication
(10) Pub. No.: US 2024/0022503 A1
(43) Pub. Date: Jan. 18, 2024

(54) HOST DEVICE, OPTICAL ACCESS SYSTEM, TRANSFER METHOD AND COMPUTER PROGRAM

(71) Applicant: NIPPON TELEGRAPH AND TELEPHONE CORPORATION, Tokyo (JP)

(72) Inventors: Satoshi SHIMAZU, Musashino-shi, Tokyo (JP); Tomoaki YOSHIDA, Musashino-shi, Tokyo (JP); Takayoshi TASHIRO, Musashino-shi, Tokyo (JP); Kenta ITO, Musashino-shi, Tokyo (JP)

(73) Assignee: NIPPON TELEGRAPH AND TELEPHONE CORPORATION, Tokyo (JP)

(21) Appl. No.: 18/035,452

(22) PCT Filed: Nov. 10, 2020
(86) PCT No.: PCT/JP2020/041896

§ 371 Date: May 4, 2023

(51) Int. Cl. H04L 45/24; H04L 45/00

(52) U.S. Cl. CPC H04L 45/245; H04L 45/22

(57) ABSTRACT

A higher-level device in an optical access system including: the higher-level device; a transition source subscriber line terminal station device before device replacement, the transition source subscriber line terminal station device communicating with the higher-level device and one or more subscriber line terminal devices; and a transition destination subscriber line terminal station device that is a device replacement destination, the higher-level device including a transfer control unit that transfers, in a case where data transmitted from the transition destination subscriber line terminal station device is received at a time of device replacement, to the transition destination subscriber line terminal station device, data addressed to one of the subscriber line terminal devices that is a transmission source of the data transmitted from the transition destination subscriber line terminal station device.

### TECHNICAL FIELD

The present invention relates to a higher-level device, an optical access system, a transfer method, and a computer program.

### BACKGROUND ART

FIG. 13 is a diagram illustrating a configuration of an optical access system 1000 in a conventional technology. The optical access system 1000 illustrated in FIG. 13 includes three optical network units (ONUs) 100-1 to 100-3, three optical line terminals (OLTs) 200-1 to 200-3, and two relay devices 300-1 to 300-2. User terminals 400-1 to 400-3 are connected to the ONUs 100-1 to 100-3, respectively. Note that the numbers of the ONUs 100, the OLTs 200, the relay devices 300, and the user terminals 400 are examples.

An OLT 200 is connected to an ONU 100 via an optical fiber, aggregates user data transmitted from respective user terminals 400, and transfers the user data to a relay device 300 belonging to a network to which the user terminals 400 belong. The OLT 200 distributes the data transmitted from the relay device 300 belonging to the network to which the user terminals 400 belong to the ONUs 100 to which the user terminals 400 as destinations are connected. In a case where the OLT 200 is physically connected to the ONUs 100 by a single star (SS) method, the OLT 200 is connected on a one-to-one basis. The OLT 200 includes a plurality of ports connected on a one-to-N basis (N is an integer greater than or equal to 1) in the case of a passive optical network (PON), and includes a plurality of ports connected to a plurality of the relay devices 300. For example, as illustrated in FIG. 13, the OLT 200 includes a plurality of ports 202-1 to 202-3 for connecting to the plurality of ONUs 100, and a plurality of ports 203-1 to 203-2 for connecting to the plurality of relay devices 300.

The OLT 200 includes a transfer table in which transfer destinations of the user data transmitted from the user terminals 400 are registered, and transfers the user data transmitted from the user terminals 400 from the ports to ports of the transfer destinations in accordance with the transfer table.

Even if a failure does not occur, the OLT 200 needs to be replaced in a planned manner for aged deterioration or provision of a new function. Hereinafter, replacement of an OLT 20 with a new OLT 200 for aged deterioration or provision of a new function will be described as transition. In the transition of the OLT 200, a setting inside the OLT 200 including a setting of the transfer table can be changed by command input or the like. On the other hand, in connection switching of the optical fiber from the OLT 200 as a transition source to the OLT 200 as a transition destination, it takes time to change a physical port to which a cable is connected.

It is desirable that communication interruption of the user terminals 400 caused by cable connection change work is as short as possible. If the entire work is prolonged, it is difficult to secure work operation. The transition is completed only after all steps are ended. If connection work, setting change work, and the like occur many times during that time, an entire work period increases, and operation of controlling the entire work is also required while securing the work operation during that time.

A conventional transition procedure will be described with reference to FIGS. 14 to 16. As illustrated in FIG. 14, a description will be given assuming that the OLT 200-2 is a transition source OLT, and the OLT 200-3 is a transition destination OLT. As illustrated in FIG. 14, the transition source OLT 200-2 includes the plurality of ports 202-1 to 202-3 for connecting to the ONUs 100 and a port 203 for connecting to the relay device 300. Similarly, the transition destination OLT 200-3 includes a plurality of ports 205-1 to 205-3 for connecting to the ONUs 100 and a port 204 for connecting to the relay device 300. A description will be given assuming that connection relationship is switched from the transition source OLT 200-2 to the transition destination OLT 200-3, as indicated by dotted lines in FIG. 14, in the transition of the OLT 200.

### (Step 1)

First, an operator newly installs the transition destination OLT 200-3 (FIG. 15(A)).

### (Step 2)

Next, the operator performs setting of the transfer table by copying or converting the transfer table to be used in the transition destination OLT 200-3 from the transition source OLT 200-2. As a result, the connection relationship between the ports of the transition destination OLT 200-3 is set similarly to that of the transition source OLT 200-2 (FIG. 15(B)). During a period from step 1 to step 2, the transition source OLT 200-2 can communicate with both the ONUs 100 and the relay device 300.

### (Step 3)

Next, the operator removes a connection line 450 (optical fiber) connecting the relay device 300 and the transition source OLT 200-2 together from the transition source OLT 200-2, and reattaches the removed connection line 450 to the port 204 of the transition destination OLT 200-3 (FIG. 15(C)). As a result, communication interruption occurs in each of the user terminals 400-1 to 400-3.

### (Step 4)

Next, the operator removes a connection line 460 (optical fiber) connecting the transition source OLT 200-2 and the ONU 100-1 together from the transition source OLT 200-2, and reattaches the removed connection line 460 to the port 205-1 of the transition destination OLT 200-3. Communication restoration of the ONU 100-1 is confirmed in the transition destination OLT 200-3. The communication restoration of the ONU 100-1 is confirmed, whereby communication between the user terminal 400-1 and the relay device 300 becomes possible (FIG. 15(D)).

### (Step 5)

Next, the operator removes a connection line 470 (optical fiber) connecting the transition source OLT 200-2 and the ONU 100-2 together from the transition source OLT 200-2, and reattaches the removed connection line 470 to the port 205-2 of the transition destination OLT 200-3. Communication restoration of the ONU 100-2 is confirmed in the transition destination OLT 200-3. The communication restoration of the ONU 100-2 is confirmed, whereby communication between the user terminal 400-2 and the relay device 300 becomes possible (FIG. 16(A)).

### (Step 6)

Next, the operator removes a connection line 480 (optical fiber) connecting the transition source OLT 200-2 and the ONU 100-3 together from the transition source OLT 200-2, and reattaches the removed connection line 480 to the port 205-3 of the transition destination OLT 200-3. Communication restoration of the ONU 100-3 is confirmed in the transition destination OLT 200-3. The communication restoration of the ONU 100-3 is confirmed, whereby communication between the user terminal 400-3 and the relay device 300 becomes possible (FIG. 16(B)).

In the above example, three ONUS 100 have been described as an example; however, in a case where four or more ONUs 100 are connected to the transition source OLT 200-2, processing similar to that in step 4 is executed as many as the number of ONUs 100.

### (Step 7)

After the connection switching of all the ONUs 100 connected to the transition source OLT 200-2 is completed, the operator removes the transition source OLT 200-2 (FIG. 16(C)). As a result, transition processing is completed.

### CITATION LIST

### Patent Literature

Patent Literature 1: JP 2011-71951 A

### Non Patent Literature

Non Patent Literature 1: Mitsui et al., “N:M PON Protection Architecture for 10 Gbit/s Class PON Systems, The IEICE Transactions B, Vol. J96-B, No. 3, pp. 283-291

### SUMMARY OF INVENTION

### Technical Problem

As described above, in a case where the connection line to the relay device 300 is switched to the transition destination OLT 200-3 first, the user terminal 400 connected to the ONU 100 for which the connection line has been switched first can recover early. On the other hand, the user terminal 400 connected to the ONU 100 whose switching order is late continues to be disconnected until the switching is completed, so that communication interruption time increases.

In a case where the connection line to the ONU 100 is switched to the transition destination OLT 200-3 first (step 3 and steps 4 to 6 are replaced with each other), the connection line connected to each ONU 100 is first switched from the transition source OLT 200-2 to the transition destination OLT 200-3. In a state where only the connection line is switched, it is a state where the communication is disconnected, and the communication cannot be resumed unless the switching of the connection line to the relay device 300 is also completed, and it takes time for the communication restoration.

As described above, in the conventional transition method, the switching of a connection between a higher-level device (for example, the relay device 300) and a lower-level device (for example, the ONU 100) and setting change of the OLT 200 are completed, and the transition is completed. Thus, in the transition of the OLT 200, it takes time to complete not only switching work but also entire work. For that reason, there has been a problem that an influence of user's communication interruption is large.

In view of the above circumstances, an object of the present invention is to provide a technology capable of suppressing the influence of communication interruption in transition of a device.

### Solution to Problem

An aspect of the present invention is a higher-level device in an optical access system including: the higher-level device; a transition source subscriber line terminal station device before device replacement, the transition source subscriber line terminal station device communicating with the higher-level device and one or more subscriber line terminal devices; and a transition destination subscriber line terminal station device that is a device replacement destination, the higher-level device including a transfer control unit that transfers, in a case where data transmitted from the transition destination subscriber line terminal station device is received at a time of device replacement, to the transition destination subscriber line terminal station device, data addressed to one of the subscriber line terminal devices that is a transmission source of the data transmitted from the transition destination subscriber line terminal station device.

An aspect of the present invention is an optical access system including: a higher-level device; a transition source subscriber line terminal station device before device replacement, the transition source subscriber line terminal station device communicating with the higher-level device and one or more subscriber line terminal devices; and a transition destination subscriber line terminal station device that is a device replacement destination, in which the transition destination subscriber line terminal station device includes: a higher-level port for connecting to the higher-level device; subscriber side connection ports for connecting to the one or more subscriber line terminal devices; and a transfer control unit that receives data transmitted from the subscriber line terminal devices at the subscriber side connection ports and transfers the data received to the higher-level device via the higher-level port, and the higher-level device includes a transfer control unit that transfers, in a case where data transmitted from the transition destination subscriber line terminal station device is received at a time of device replacement, to the transition destination subscriber line terminal station device, data addressed to one of the subscriber line terminal devices that is a transmission source of the data transmitted from the transition destination subscriber line terminal station device.

An aspect of the present invention is a transfer method performed by a higher-level device in an optical access system including: the higher-level device; a transition source subscriber line terminal station device before device replacement, the transition source subscriber line terminal station device communicating with the higher-level device and one or more subscriber line terminal devices; and a transition destination subscriber line terminal station device that is a device replacement destination, the transfer method including transferring, in a case where data transmitted from the transition destination subscriber line terminal station device is received at a time of device replacement, to the transition destination subscriber line terminal station device, data addressed to one of the subscriber line terminal devices that is a transmission source of the data transmitted from the transition destination subscriber line terminal station device.

An aspect of the present invention is a computer program for causing a computer that functions as a higher-level device in an optical access system including: the higher-level device; a transition source subscriber line terminal station device before device replacement, the transition source subscriber line terminal station device communicating with the higher-level device and one or more subscriber line terminal devices; and a transition destination subscriber line terminal station device that is a device replacement destination, to execute a step of transferring, in a case where data transmitted from the transition destination subscriber line terminal station device is received at a time of device replacement, to the transition destination subscriber line terminal station device, data addressed to one of the subscriber line terminal devices that is a transmission source of the data transmitted from the transition destination subscriber line terminal station device.

### Advantageous Effects of Invention

According to the present invention, it is possible to suppress the influence of communication interruption in transition of a device.

### BRIEF DESCRIPTION OF DRAWINGS

FIG. 1 is a diagram illustrating a configuration example of an optical access system in a first embodiment.

FIG. 2 is a schematic diagram illustrating a specific configuration of a relay device in the first embodiment.

FIG. 3 is a diagram for explaining an outline of processing at the time of OLT transition of the optical access system in the first embodiment.

FIG. 4 is a diagram for explaining the outline of the processing at the time of OLT transition of the optical access system in the first embodiment.

FIG. 5 is a sequence diagram illustrating a flow of the processing at the time of OLT transition of the optical access system in the first embodiment.

FIG. 6 is a diagram illustrating a configuration example of an optical access system in a second embodiment.

FIG. 7 is a schematic diagram illustrating a specific configuration of a transition assistance device in the second embodiment.

FIG. 8 is a diagram for explaining an outline of processing at the time of OLT transition of the optical access system in the second embodiment.

FIG. 9 is a diagram for explaining the outline of the processing at the time of OLT transition of the optical access system in the second embodiment.

FIG. 10 is a diagram for explaining the outline of the processing at the time of OLT transition of the optical access system in the second embodiment.

FIG. 11 is a sequence diagram for explaining a flow of processing at the time of transition in the optical access system in the second embodiment.

FIG. 12 is a sequence diagram for explaining the flow of the processing at the time of transition in the optical access system in the second embodiment.

FIG. 13 is a diagram illustrating a configuration of an optical access system in a conventional technology.

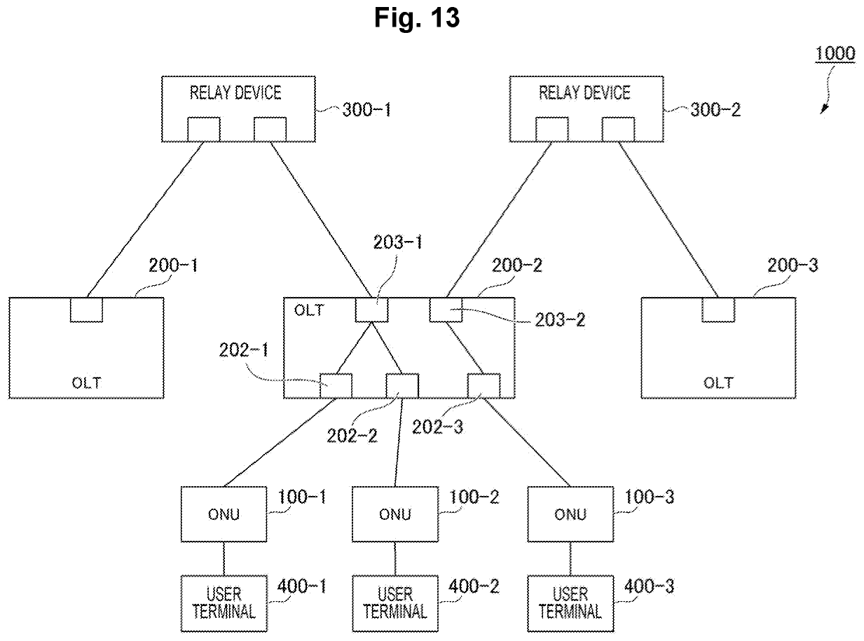

FIG. 14 is a schematic diagram for explaining the conventional transition procedure.

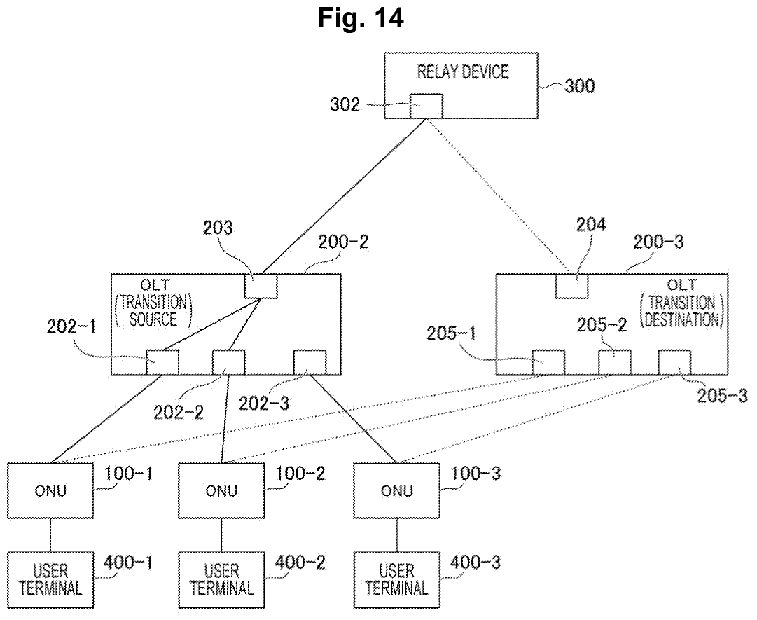

FIG. 15 is a schematic diagram for explaining the conventional transition procedure.

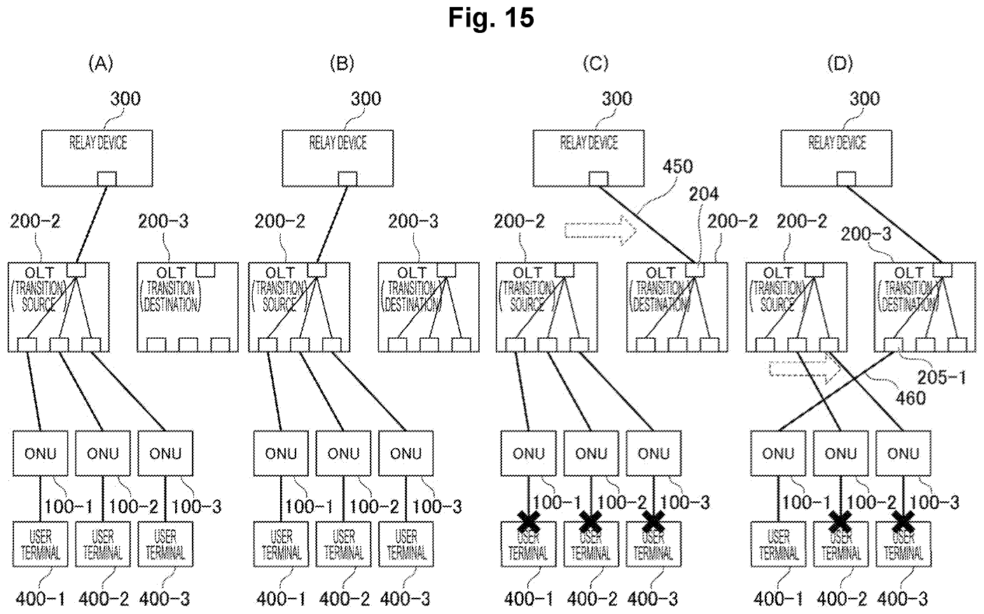

FIG. 16 is a schematic diagram for explaining the conventional transition procedure.

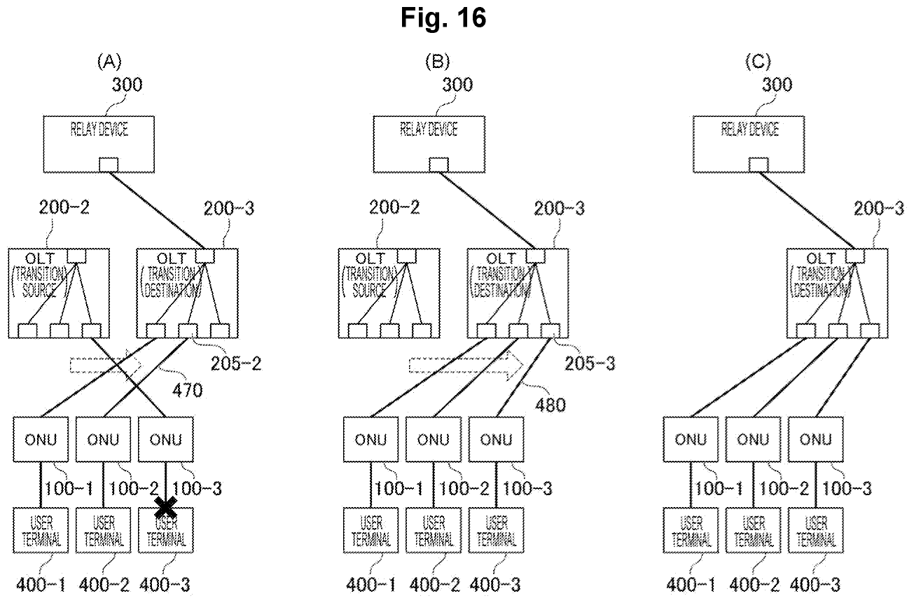

### DESCRIPTION OF EMBODIMENTS

Hereinafter, an embodiment of the present invention will be described with reference to the drawings.

### OUTLINE

In an optical access system in the present invention, at the time of replacement of an OLT, a relay device performs link aggregation group (LAG) connection between a transition source OLT and a transition destination OLT. When detecting that data whose transmission source is an ONU (for example, a first ONU) is received from a transition destination OLT, the relay device transfers data addressed to the first ONU to the transition destination OLT. As a result, communication with the ONU whose connection has been newly switched to the transition destination OLT is performed via the transition destination OLT. For that reason, it is possible to sequentially resume communication even if all processing is not completed for transition of the OLT as in the conventional method. For that reason, it is possible to suppress an influence of communication interruption in transition of a device.

Hereinafter, a specific configuration will be described.

### First Embodiment

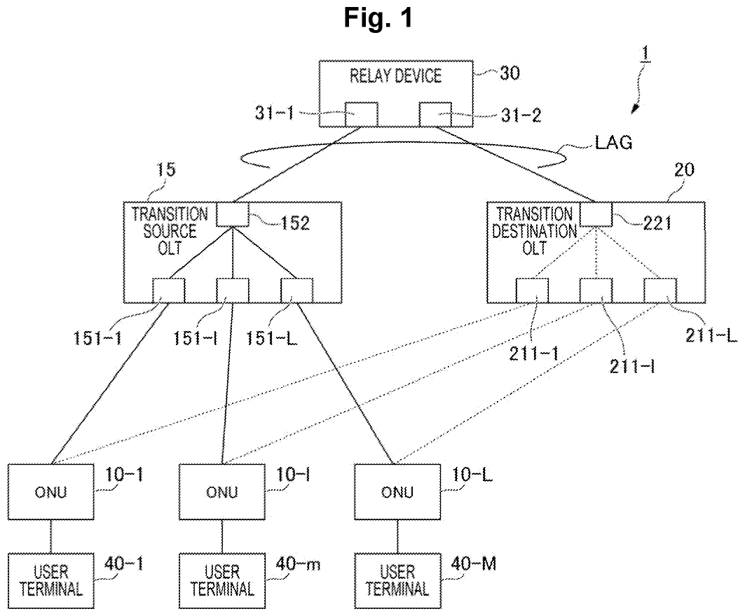

FIG. 1 is a diagram illustrating a configuration example of an optical access system 1 in a first embodiment.

The optical access system 1 includes one or more ONUS 10-1 to 10-L (L is an integer greater than or equal to 1), a transition source OLT 15 (transition source subscriber line terminal station device), a transition destination OLT 20 (transition destination subscriber line terminal station device), and a relay device 30. The transition source OLT 15 and the ONUS 10-1 to 10-L are connected to each other via optical fibers. The transition source OLT 15 and the relay device 30 are connected to each other via an optical fiber. The numbers of the ONUS 10, the transition source OLTs 15, the transition destination OLTs 20, and the relay devices 30 included in the optical access system 1 are not particularly limited.

User terminals 40-1 to 400-M (M is an integer greater than or equal to 1) are connected to the ONUS 10-1 to 10-L, respectively. In FIG. 1, the user terminal 40-1 is connected to the ONU 10-1, the user terminal 40-m (m≤M) is connected to the ONU 10-1 (1 L), and the user terminal 40-M is connected to the ONU 10-L. Further, the relay device 30 is connected to a higher level of the transition source OLT 15, and the ONUS 10-1 to 10-L are connected to a lower level of the transition source OLT 15. In the following description, the ONUS 10-1 to 10-L will be simply referred to as ONUS 10 unless otherwise distinguished.

An ONU 10 is installed, for example, in the home of a subscriber who receives provision of a communication service. The ONU 10 transmits user data transmitted from a user terminal 40 to a destination communication device via the transition source OLT 15 and the relay device 30. In a case where a connection destination is changed from the transition source OLT 15 to the transition destination OLT 20 due to transition, the ONU 10 transmits the user data transmitted from the user terminal 40 to the destination communication device via the transition destination OLT 20 and the relay device 30.

The transition source OLT 15 is an OLT that is replaced for aged deterioration or provision of a new function. The transition source OLT 15 includes ONU connection ports 151-1 to 151-L for connecting to the ONUS 10, and a relay port 152. Further, the transition source OLT 15 includes a transfer table in which a destination, a reception port, and a transfer destination port are associated with each other, and transfers data in accordance with the transfer table. In the following description, it is assumed that the following information is registered in the transfer table included in the transition source OLT 15.
Destination “relay device 30”, reception port “ONU connection port 151”, transfer destination “relay port 152”
Destination “ONU 10”, reception port “relay port 152”, transfer destination “ONU connection port 151”

With the above setting, the transition source OLT 15 receives data transmitted from the ONU 10 at the ONU connection port 151, and transfers the received data to the relay device 30 via the relay port 152 in accordance with the transfer table. The transition source OLT 15 receives data transmitted from the relay device 30 at the relay port 152, and transfers the received data to the ONU 10 via the ONU connection port 151 in accordance with the transfer table.

The transition destination OLT 20 is an OLT to be a transition destination from the transition source OLT 15. The ONU 10 and the transition destination OLT 20 are not connected to each other at the start of transition as indicated by points in FIG. 1, and each ONU 10 is connected to the transition destination OLT 20 when the transition is started. The transition destination OLT 20 includes ONU connection ports 211-1 to 211-L for connecting to the ONUS 10, and a relay port 221. Further, similarly to the transition source OLT 15, the transition destination OLT 20 includes a transfer table and transfers data in accordance with the transfer table. In the following description, it is assumed that the following information is registered in the transfer table included in the transition destination OLT 20.
Destination “relay device 30”, reception port “ONU connection port 211”, transfer destination “relay port 221”
Destination “ONU 10”, reception port “relay port 221”, transfer destination “ONU connection port 211”

With the above setting, the transition destination OLT 20 receives data transmitted from the ONU 10 at the ONU connection port 211, and transfers the received data to the relay device 30 via the relay port 221 in accordance with the transfer table. The transition destination OLT 20 receives data transmitted from the relay device 30 at the relay port 221, and transfers the received data to the ONU 10 via the ONU connection port 211 in accordance with the transfer table.

The relay device 30 is a device located at the higher level of the transition source OLT 15 and the transition destination OLT 20. The relay device 30 includes a plurality of OLT connection ports 31-1 to 31-2 for connecting to the transition source OLT 15 and the transition destination OLT 20. Note that the number of OLT connection ports 31 may be three or more. The relay device 30 performs setting of link aggregation for the plurality of OLT connection ports 31-1 to 31-2, and performs LAG connection between the transition source OLT 15 and the transition destination OLT 20. In the following, a description will be given with the OLT connection port 31 as a port for connecting to the transition source OLT 15, and the OLT connection port 32 as a port for connecting to the transition destination OLT 20.

Further, with reception of data transmitted from the transition destination OLT 20 as a trigger, in subsequent processing, when data addressed to the transmission source of the data transmitted from the transition destination OLT 20 is received, the relay device 30 transmits the data to the transition destination OLT 20. For example, it is assumed that the relay device 30 receives data whose transmission source is the ONU 10-1 transmitted from the transition destination OLT 20. In this case, when the data addressed to the ONU 10-1 is received from other devices in subsequent processing, the relay device 30 transmits the received data to the transition destination OLT 20. As a result, it becomes possible to transfer data addressed to the ONU 10 connected to the transition destination OLT 20. The other devices are communication devices other than devices located at the lower level of the relay device 30, such as other relay devices belonging to the same network and relay devices belonging to other networks.

The user terminal 40 is a communication terminal possessed by the subscriber. The user terminal 40 transmits data to the ONU 10 depending on operation. The user terminal 40 receives the data transmitted from the ONU 10. The user terminal 40 is configured using an information processing device.

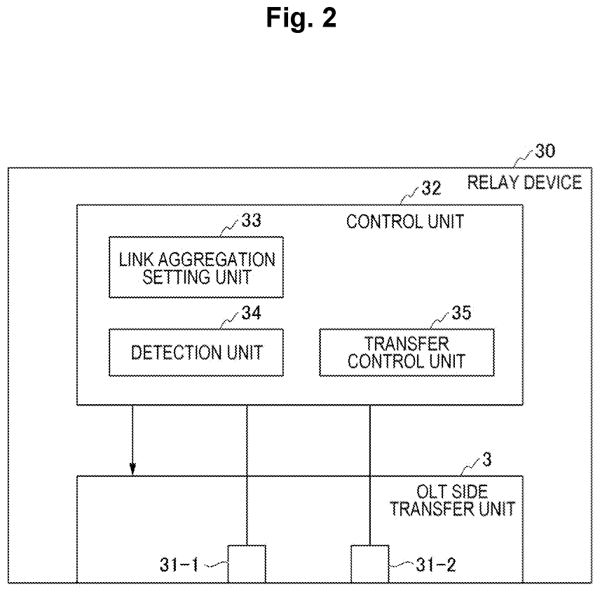

FIG. 2 is a schematic diagram illustrating a specific configuration of the relay device 30 in the first embodiment.

The relay device 30 includes an OLT side transfer unit 3 and a control unit 32.

The OLT side transfer unit 3 includes the plurality of OLT connection ports 31-1 to 31-2, and transmits and receives data to and from the transition source OLT 15 and the transition destination OLT 20 via the OLT connection ports 31-1 to 31-2.

The control unit 32 includes a processor such as a central processing unit (CPU) and a memory. The control unit 32 implements functions of a link aggregation setting unit 33, a detection unit 34, and a transfer control unit 35 by executing a program. Some of these functions (for example, some of the link aggregation setting unit 33, the detection unit 34, and the transfer control unit 35) do not necessarily have to be installed in the relay device 30 in advance, and may be implemented by installing an additional application program in the relay device 30.

The link aggregation setting unit 33 performs setting of link aggregation for the OLT side transfer unit 3 depending on an instruction from the outside at the time of transition. For example, the link aggregation setting unit 33 sets an identification information Lag1 for the OLT connection port 31-1 and sets an identification information Lag2 for the OLT connection port 31-2. The OLT connection port 31-1 is a port to be connected to the transition source OLT 15. For that reason, at the time of transition, it is necessary to set the identification information Lag1 also for the relay port 152 of transition source OLT 15. The OLT connection port 31-2 is a port to be connected to the transition destination OLT 20. For that reason, at the time of transition, it is necessary to set the identification information Lag2 also for the relay port 221 of transition destination OLT 20.

The detection unit 34 detects the data transmitted from the transition destination OLT 20.

The transfer control unit 35 transfers data between another relay device and an OLT (for example, the transition source OLT 15 and the transition destination OLT 20). Specifically, the transfer control unit 35 transfers data transferred from the other relay device to the transition source OLT 15 via the OLT side transfer unit 3. When the data transmitted from the transition destination OLT 20 is detected by the detection unit 34, the transfer control unit 35 transfers data addressed to the ONU 10 that is the transmission source of the detected data to the transition destination OLT 20 via the OLT side transfer unit 3.

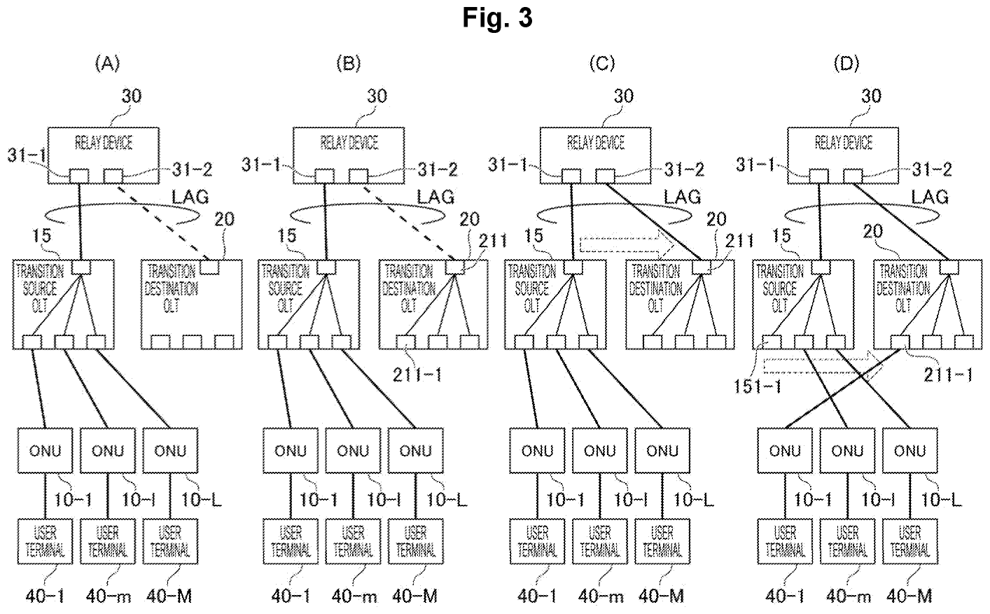

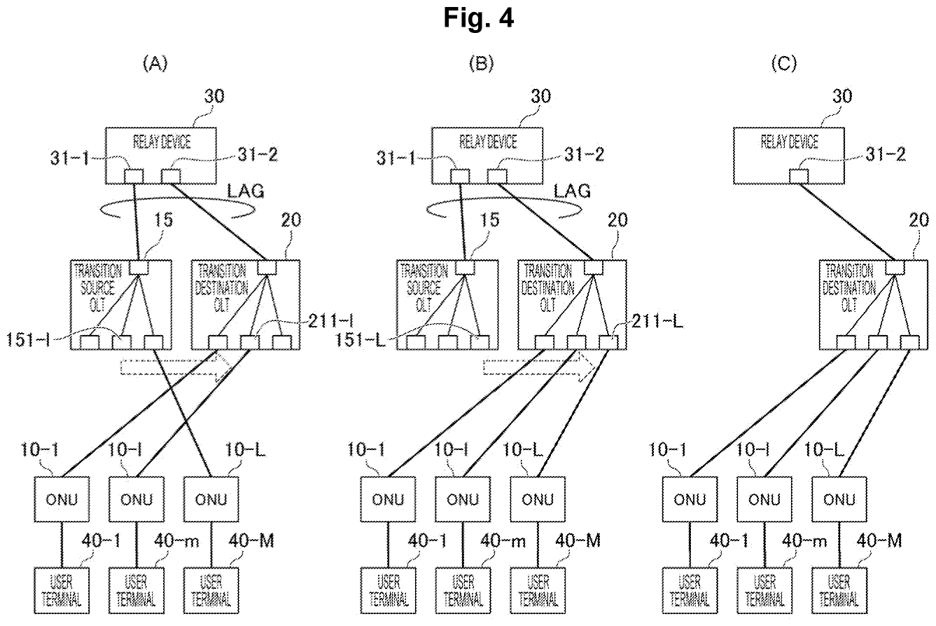

Next, with reference to FIGS. 3 and 4, a description will be given of an outline of processing at the time of OLT transition of the optical access system 1 in the first embodiment. FIGS. 3 and 4 are diagrams for explaining the outline of the processing at the time of OLT transition of the optical access system 1 in the first embodiment.

In a state before the start of transition, one or more ONUS 10 and the relay device 30 are in communication via the transition source OLT 15. When starting the transition of the OLT, the operator installs the transition destination OLT 20 (FIG. 3(A)). It is assumed that setting of link aggregation has been performed between the relay device 30 and the transition source OLT 15 in a state before the start of transition. In this case, LAG connection is performed between the OLT connection ports 31-1 and 31-2 of the relay device 30 and the transition source OLT 15.

Next, the operator performs setting of the transfer table of the transition destination OLT 20 (FIG. 3(B)). For example, as the setting of the transfer table, the operator performs setting so that data output from the relay port 221 is transferred to the ONU connection port 211 and data output from the ONU connection port 211 is transferred to the relay port 221.

Next, the operator performs replacement of the connection destination port of the connection line of the OLT connection port 31 of the relay device 30 (FIG. 3(C)). Specifically, the operator attaches the optical fiber connected to the OLT connection port 31-2 of the relay device 30 to the relay port 221 of the transition destination OLT 20. Along with this work, the operator changes the setting of link aggregation. For example, the setting is changed so that LAG connection is performed between the OLT connection port 31-1 of the relay device 30 and the transition source OLT 15, and LAG connection is performed between the OLT connection port 31-2 of the relay device 30 and the transition destination OLT 20.

Next, the operator performs switching of the connection on the ONU 10-1 side of the transition destination OLT 20 (FIG. 3(D)). Specifically, as illustrated in FIG. 3(D), the operator attaches the optical fiber connected to the ONU connection port 151-1 of the transition source OLT 15 to the ONU connection port 211-1 of the transition destination OLT 20. As a result, the ONU 10-1 can communicate via the transition destination OLT 20.

Next, the operator performs switching of the connection on the ONU 10-2 side of the transition destination OLT 20 (FIG. 4(A)). Specifically, as illustrated in FIG. 4(A), the operator attaches the optical fiber connected to the ONU connection port 151-1 of the transition source OLT 15 to the ONU connection port 211-1 of the transition destination OLT 20. As a result, the ONU 10-1 can communicate via the transition destination OLT 20.

Next, the operator performs switching of the connection on the ONU 10-L side of the transition destination OLT 20 (FIG. 4(B)). Specifically, as illustrated in FIG. 4(B), the operator attaches the optical fiber connected to the ONU connection port 151-L of the transition source OLT 15 to the ONU connection port 211-L of the transition destination OLT 20. As a result, the ONU can communicate via the transition destination OLT 20.

With the above processing, the ONU 10 connected to the transition source OLT 15 is connected to the transition destination OLT 20.

Thereafter, the operator removes the transition source OLT 15 and extra wiring (for example, an optical fiber) (FIG. 4(C)).

As a result, the transition of the OLT is completed.

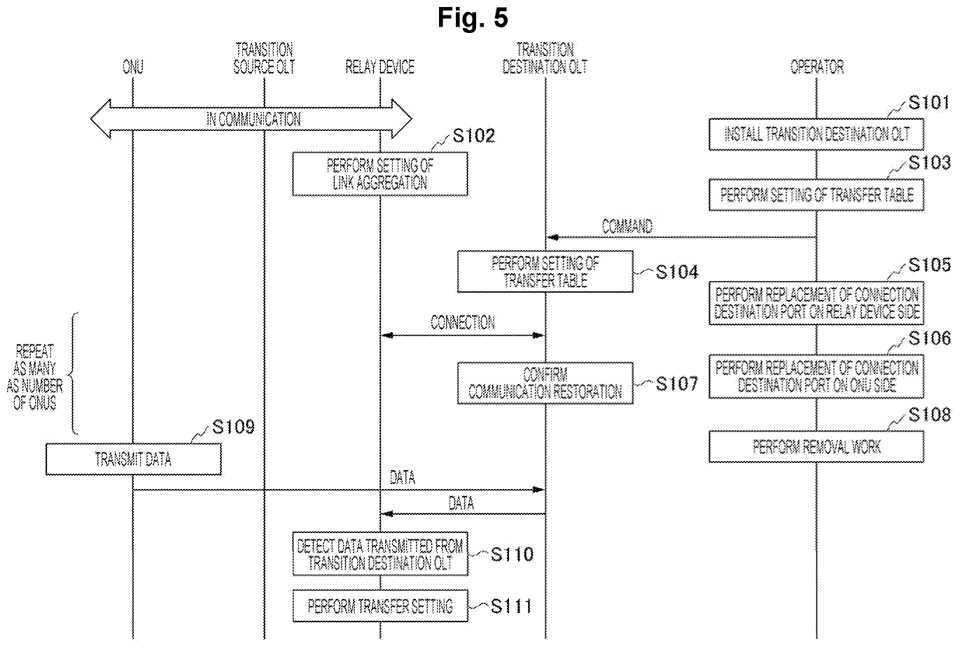

In FIGS. 3 and 4, the outline of the processing at the time of OLT transition has been described. Thus, next, processing of each device at the time of transition will be specifically described with reference to FIG. 5. FIG. 5 is a sequence diagram illustrating a flow of the processing at the time of OLT transition of the optical access system 1 in the first embodiment.

At the start of the processing of FIG. 5, it is assumed that the ONU 10 and the relay device 30 are in communication with each other via the transition source OLT 15. First, the operator installs the transition destination OLT 20 (step S101). As a result, the transition destination OLT 20 is installed near the transition source OLT 15. Next, the operator operates an external device to perform setting of link aggregation of the relay device 30. For example, as illustrated in FIG. 3(A), the operator performs setting so that LAG connection is performed between the OLT connection ports 31-1 and 31-2 of the relay device 30 and the transition source OLT 15. The link aggregation setting unit 33 performs setting of link aggregation depending on an instruction from the external device (step S102). As a result, LAG connection is performed between the OLT connection ports 31-1 and 31-2 of the relay device 30 and the transition source OLT 15.

Next, the operator performs setting of the transfer table of the transition destination OLT 20 (step S103). For example, the operator performs setting of the transfer table of the transition destination OLT 20 on the basis of the transfer table of the transition source OLT 15. The external device transmits a setting change command to the transition destination OLT 20.

For example, the operator operates the external device to transmit, to the transition destination OLT 20, a command for causing Contents 1 and 2 described below to be set in the transfer table.

(Content 1) A content for causing a destination “relay device 30”, a reception port “ONU connection port 211”, and a transfer destination “relay port 221” to be set.

Content 1 is a content for causing settings to be set so that in a case where the data whose destination is the relay device 30 is received at the ONU connection port 211 of the transition destination OLT 20, the received data is transferred to the relay port 221.

(Content 2) Destination “ONU 10”, reception port “relay port 221”, and transfer destination “ONU connection port 211”.

Content 2 is a content for causing settings to be set so that in a case where the data whose destination is ONU 10 is received at the relay port 221, the received data is transferred to the ONU connection port 211.

The transition destination OLT 20 performs setting of the transfer table in accordance with the command transmitted from the external device (step S104).

Next, the operator performs replacement of the connection destination port of the relay port 221 of the transition destination OLT 20 (step S105). Since the specific processing in step S105 is described in FIG. 3(C), the description thereof is omitted.

Next, the operator performs replacement of the connection destination port on the ONU 10 side of the transition destination OLT 20 (step S106). Since the specific processing of step S106 is described in FIGS. 3(D) to 4(B), the description thereof is omitted.

For example, in a case where the transition destination OLT 20 and the ONU 10-1 are connected to each other in the processing of step S106, communication restoration of the ONU 10-1 is confirmed in the transition destination OLT 20 (step S107). When the communication restoration of the ONU 10-1 is confirmed, data can be transmitted and received between the transition destination OLT 20 and the ONU 10-1.

The operator executes the processing from step S106 to step S107 as many as the number of ONUS 10 connected to the transition source OLT 15. As a result, all the ONUS 10 connected to the transition source OLT 15 are connected to the transition destination OLT 20.

With the above processing, all the ONUS 10 connected to the transition destination OLT 20 can communicate with the relay device 30 without passing through the transition source OLT 15. Thereafter, the operator removes the transition source OLT 15 and unnecessary wiring (step S108).

The above description is the description of the processing of transition from the transition source OLT 15 to the transition destination OLT 20, and the processing after the ONU 10 is connected to the transition destination OLT 20 will be further described. The processing from step S109 to step S111 described below is performed by the ONU 10 connected to the transition destination OLT 20 and enabled to communicate.

The ONU 10 transmits data to the transition destination OLT 20 (step S109). For example, the ONU 10-1 transmits data to the transition destination OLT 20.

The transition destination OLT 20 receives the data transmitted from the ONU 10-1 at the ONU connection port 211-1. On the basis of the received data and the ONU connection port 211 receiving the data, the transition destination OLT 20 refers to the transfer table and determines a transfer destination of the data. For example, in the transfer table included in the transition destination OLT 20, in a case where the destination is the relay device 30 and the reception port is the ONU connection port 211, the transfer destination is set to the relay port 221. Thus, the transition destination OLT 20 transfers the received data to the relay port 221.

The relay port 221 is connected to the relay device 30 via an optical fiber. For that reason, the data output from the relay port 221 is input to the relay device 30. The relay device 30 transfers the received data to a relay device of a network to which a communication device as a destination belongs. As described above, the uplink data transmission from the ONU 10 to the relay device 30 becomes possible.

The relay device 30 receives the data transmitted from the transition destination OLT 20 by the OLT side transfer unit 3. The detection unit 34 detects that the data received by the OLT side transfer unit 3 is the data transmitted from the transition destination OLT 20 (step S110). The detection unit 34 notifies the transfer control unit 35 that the data transmitted from the transition destination OLT 20 is detected. Upon receiving the notification from the detection unit 34, the transfer control unit 35 acquires information of the ONU 10 that is the transmission source of the data transmitted from the transition destination OLT 20. The information of the ONU 10 that is the transmission source may be, for example, identification information (MAC address or the like) of the ONU 10. The transfer control unit 35 performs transfer setting on the basis of the acquired information of the ONU 10 (step S111). For example, it is assumed that the transfer control unit 35 acquires information for identifying the ONU 10-1.

In this case, the transfer control unit 35 transfers the data addressed to the ONU 10-1 to the transition destination OLT 20. For example, the transfer control unit 35 updates information of the transfer table used for transfer in the relay device 30, and sets the transfer destination with the destination of “ONU 10-1” as “OLT connection port 31-2” to which the transition destination OLT 20 is connected. As a result, in a case where the data addressed to the ONU 10-1 is received in the relay device 30 in the subsequent processing, the data is transferred to the transition destination OLT 20 instead of the transition source OLT 15.

According to the optical access system 1 configured as described above, it is possible to suppress an influence of communication interruption in transition of a device. Specifically, the relay device 30 performs LAG connection between the transition source OLT 15 and the transition destination OLT 20. When detecting that data whose transmission source is the ONU 10 (for example, the ONU 10-1) is received from the transition destination OLT 20, the relay device 30 transfers the data addressed to the ONU 10-1 to the transition destination OLT 20. As a result, communication with the ONU 10 whose connection has been newly switched to the transition destination OLT 20 is performed via the transition destination OLT 20. For that reason, it is possible to sequentially resume communication even if all processing is not completed for transition of the OLT as in the conventional method. For that reason, it is possible to suppress an influence of communication interruption in transition of a device.

In the present invention, link aggregation connection is performed in the relay device 30. Merit of performing the link aggregation connection described above is as follows. It is assumed that one link is logically formed by the link aggregation connection before the transition, and a setting of transfer from the relay device 30 to a higher-level device has been set in the relay device 30. Thereafter, although transition of the OLT is performed, when a new port for connecting the transition destination OLT 20 is set to the relay device 30 instead of the link aggregation connection, the setting of transfer to the higher-level device is required for the new port (if a configuration of transfer to the higher-level device is not changed before and after the OLT transition, the setting of transfer is the same as that of the port before transition of the relay device).

On the other hand, when the link aggregation connection is performed as in the present invention, the setting of transfer from the relay device 30 to the higher-level device becomes unnecessary. As described above, since the setting of transfer to the higher-level device can be made unnecessary, a burden on a worker can be reduced.

In the conventional method, whether or not the transfer setting is successfully copied and converted, and whether or not the port of the connection switching destination is correctly connected, are confirmed after the connection switching or the setting change is performed, but whether or not they are correctly performed so that the user's communication finally is restored cannot be confirmed until both the relay device side connection line and the ONU side connection line are switched. If the communication is not restored, there has been a problem that a switch-back step is complicated, it takes time for cause investigation, and the communication interruption increases considerably.

On the other hand, in the optical access system 1, whether or not the transfer setting is successfully copied and converted, and whether or not the port of the connection switching destination is correctly connected can be confirmed in a form of user's communication restoration for each piece of work. As a result, a switch-back determination can be made in each step, and it is possible to suppress an increase in the communication interruption time due to the switch-back work.

Since connection work between the transition destination OLT 20 and the relay device 30 and connection work between the transition destination OLT 20 and the ONU 10 are physical configurations, local work is required; however, update of the transfer table and switching of the optical SW 214 can be performed collectively and remotely, and its step can be divided. For that reason, appropriate technicians and time can be allocated to each step.

### Second Embodiment

In a second embodiment, a device is used that assists transition of an OLT and can switch connection of an ONU from a transition source OLT to a transition destination OLT.

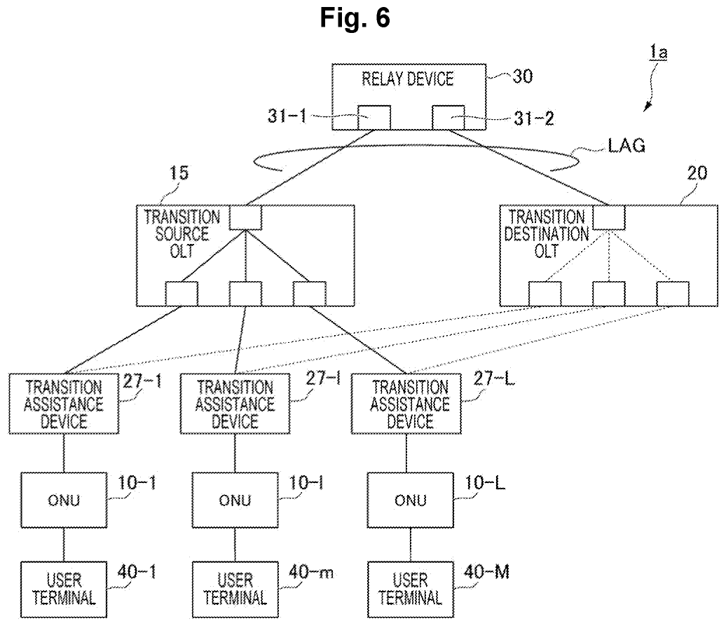

FIG. 6 is a diagram illustrating a configuration example of an optical access system la in the second embodiment.

The optical access system la includes one or more ONUs 10-1 to 10-L (L is an integer greater than or equal to 1), a transition source OLT 15, a transition destination OLT 20, one or more transition assistance devices 27-1 to 27-L, and a relay device 30. Before the start of transition, the transition source OLT 15 and the ONUs 10-1 to 10-L are connected to each other via optical fibers. Before the start of transition, the transition source OLT 15 and the relay device 30 are connected to each other via an optical fiber. The numbers of the ONUs 10, the transition source OLTs 15, the transition destination OLTs 20, the transition assistance device 27, and the relay devices 30 included in the optical access system 1 are not particularly limited.

In FIG. 6, the transition assistance device 27 is provided between the ONU 10 and the transition source OLT 15, but since the transition assistance device 27 is not provided before the start of transition, the ONU 10 and the transition source OLT 15 are directly connected to each other. On the other hand, when the transition is started, the transition assistance device 27 is installed between the ONU 10 and the transition source OLT 15 and processing is performed, which is different from the first embodiment. Hereinafter, differences from the first embodiment will be described.

The transition assistance device 27 is a device that assists transition of an OLT and can switch connection of the ONU 10 from the transition source OLT 15 to the transition destination OLT 20. The transition assistance device 27 is provided, for example, between the ONU 10 and the transition source OLT 15 at the start of transition, and transfers data transmitted from the transition source OLT 15 to the ONU 10 or data transmitted from the ONU 10 to the transition source OLT 15. At the time of transition, the transition assistance device 27 cuts, for example, an optical fiber connected to the transition source OLT 15, and communicably connects the transition destination OLT 20 and the ONU 10 to each other. The transition assistance devices 27-1 to 27-L have the same configuration.

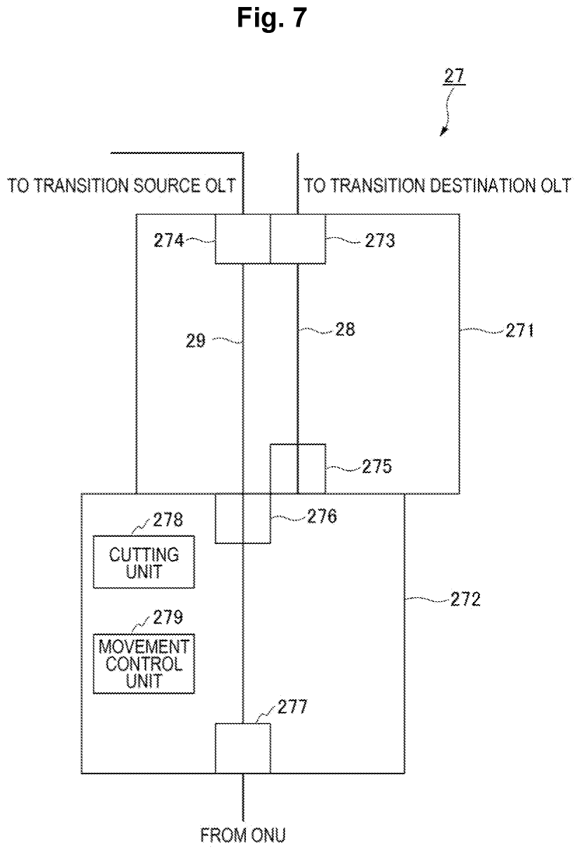

FIG. 7 is a schematic diagram illustrating a specific configuration of the transition assistance device 27.

The transition assistance device 27 includes a fixed member 271 (first member) and a movable member 272 (second member). In the transition assistance device 27, the movable member 272 is movable, and an optical fiber provided in the fixed member 271 for connecting to the transition destination OLT 20 and an optical fiber provided in the movable member 272 for connecting to the ONU 10 are connected together by fusion, whereby communication is enabled between the ONU 10 and the transition destination OLT 20.

More specifically, in the transition assistance device 27, when the movable member 272 moves and an outer side of the movable member 272 and an outer side of the fixed member 271 are aligned with each other, positions of fusion mechanisms included in the fixed member 271 and the movable member 272 substantially coincide with each other. The fusion mechanisms each are a fusion machine generally used for fusing optical fibers together.

The fixed member 271 includes a transition destination OLT connection port 273 (first port), a transition source OLT connection port 274 (second port), and a fusion mechanism 275 (connection unit).

The transition destination OLT connection port 273 is a port for communicating with the transition destination OLT 20. An optical fiber to be connected to the transition destination OLT 20 is attached to the transition destination OLT connection port 273.

The transition source OLT connection port 274 is a port for communicating with the transition source OLT 15. An optical fiber to be connected to the transition source OLT 15 is attached to the transition source OLT connection port 274.

The fusion mechanism 275 is a member having a function for fusing optical fibers together. An optical fiber 28 is installed between the fusion mechanism 275 and the transition destination OLT connection port 273. The fusion mechanism 275 connects the optical fiber provided in the movable member 272 and the optical fiber 28 together by fusion. In performing fusion, core positions of the optical fibers are aligned with each other by a core alignment technology of a fusion machine described in Reference Literature 1 below. As a result, a transition destination OLT connection port 273-1 and an ONU connection port 277-1 can be connected to each other by a connection line.

(Reference Document 1: “Core alignment fusion splicer 90S Faster. More accurately.”,

URL:https://e431.jp/upload/save_file/02171736_5e4a509e468db.pdf)

The movable member 272 is a member that is operated externally or manually. The movable member 272 includes a fusion mechanism 276 (connection unit), an ONU connection port 277, a cutting unit 278, and a movement control unit 279.

The fusion mechanism 276 is a member having a function for fusing optical fibers together. At the start of transition, the fusion mechanism 276 is located between the transition source OLT connection port 274 and the ONU connection port 277. An optical fiber 29 connecting the transition source OLT connection port 274 and the ONU connection port 277 to each other passes through the fusion mechanism 276. Then, at the time of transition, the fusion mechanism 276 connects the optical fiber provided in the fusion mechanism 275 and the optical fiber provided in the movable member 272 together by fusion.

The ONU connection port 277 is a port for communicating with the ONU 10. For example, an optical fiber for connecting to the ONU 10 is attached to the ONU connection port 277.

The cutting unit 278 cuts the optical fiber in accordance with an instruction from the outside. Specifically, the cutting unit 278 cuts the optical fiber protruding from the fusion mechanism 276 between the fixed member 271 and the movable member 272. The cutting unit 278 is, for example, an automatic fiber cutter.

The movement control unit 279 moves the movable member 272 in accordance with an instruction from the outside. Specifically, the movement control unit 279 moves the movable member 272 to a position where a position of the optical fiber in the fusion mechanism 276 coincides with a position of the optical fiber in the fusion mechanism 275. In a case where a distance to the position where the position of the optical fiber in the fusion mechanism 276 coincides with the position of the optical fiber in the fusion mechanism 275 is determined in advance, the movement control unit 279 may move the movable member 272 by the distance determined in advance.

Note that, since the transition assistance device 27 is configured by attaching other components included in the fixed member 271 and the movable member 272 to the fusion machines (the fusion mechanisms 275 and 276), it is possible to remove a functional unit that is detachable and is unnecessary after the transition is finished. That is, after the transition is completed, the components other than the fusion mechanisms 275 and 276 can be removed.

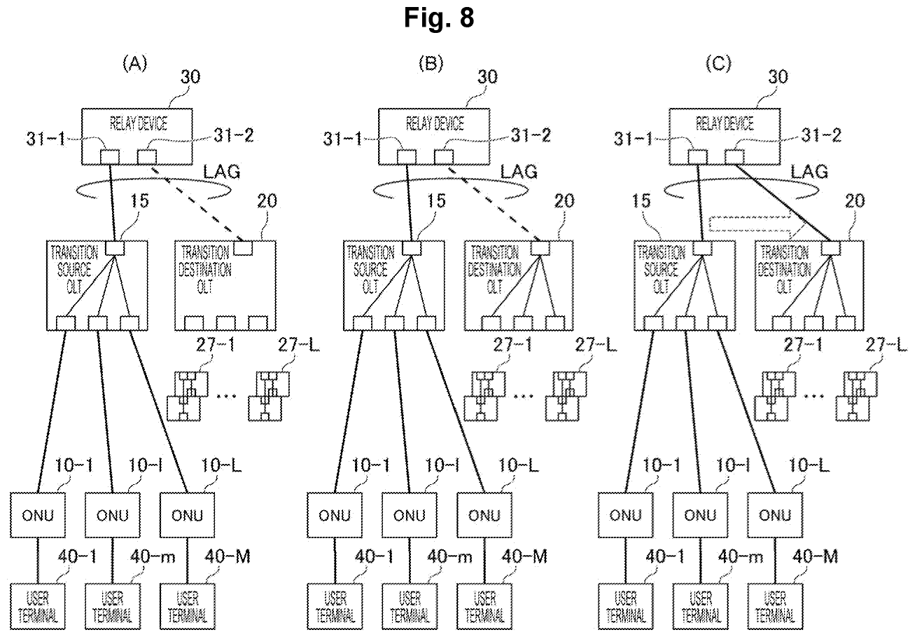

Next, with reference to FIGS. 8 to 10, a description will be given of an outline of processing at the time of OLT transition of the optical access system la in the second embodiment. FIGS. 8 to 10 are diagrams for explaining the outline of the processing at the time of OLT transition of the optical access system la in the second embodiment.

In a state before the start of transition, one or more ONUs 10 and the relay device 30 are in communication via the transition source OLT 15. When starting the transition of the OLT, the operator installs the transition destination OLT 20 and the transition assistance device 27 (FIG. 8(A)). The number of the transition assistance devices 27 to be installed may be equal to the number of the transition destination OLTs 20. It is assumed that setting of link aggregation has been performed between the relay device 30 and the transition source OLT 15 in a state before the start of transition. In this case, LAG connection is performed between the OLT connection ports 31-1 and 31-2 of the relay device 30 and the transition source OLT 15.

Next, the operator performs setting of the transfer table of the transition destination OLT 20 (FIG. 8(B)). For example, as the setting of the transfer table, the operator performs setting so that data output from the relay port 221 is transferred to the ONU connection port 211 and data output from the ONU connection port 211 is transferred to the relay port 221.

Next, the operator performs replacement of the connection destination port of the connection line of the OLT connection port 31 of the relay device 30 (FIG. 8(C)). Specifically, the operator attaches the optical fiber connected to the OLT connection port 31-2 of the relay device 30 to the relay port 221 of the transition destination OLT 20. Along with this work, the operator changes the setting of link aggregation. For example, the setting is changed so that LAG connection is performed between the OLT connection port 31-1 of the relay device 30 and the transition source OLT 15, and LAG connection is performed between the OLT connection port 31-2 of the relay device 30 and the transition destination OLT 20.

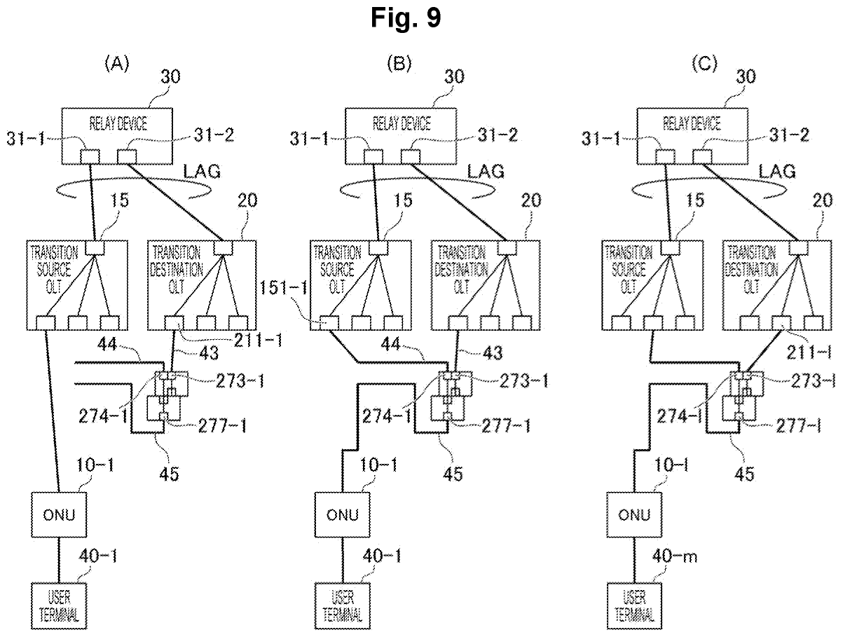

Next, the operator performs wiring on the ONU 10-1 side of the transition destination OLT 20 and wiring of the transition assistance device 27 (FIG. 9(A)). Specifically, as illustrated in FIG. 9(A), the operator attaches the optical fiber 43 to the ONU connection port 211-1 of the transition destination OLT 20, attaches the optical fiber 44 to the transition source OLT connection port 274-1 of the transition assistance device 27-1, and attaches the optical fiber 45 to the ONU connection port 277-1 of the transition assistance device 27-1.

Next, the operator performs connection of the wiring on the ONU 10-1 side of the transition destination OLT 20 and the wiring of the transition assistance device 27 (FIG. 9(B)). Specifically, first, the operator removes the optical fiber connecting the ONU 10-1 and the transition source OLT 15 to each other. With this work, connection between the ONU 10-1 and the relay device 30 is disconnected, whereby communication interruption occurs in the ONU 10-1.

The operator attaches the optical fiber 43 connected to the ONU connection port 211-1 of the transition destination OLT 20 to the transition destination OLT connection port 273-1 of the transition assistance device 27-1. Further, the operator attaches the optical fiber 44 connected to the transition source OLT connection port 274-1 of the transition assistance device 27-1 to the port 152 of the transition source OLT 15. Further, the operator connects the optical fiber 45 connected to the ONU connection port 277-1 of the transition assistance device 27-1 and the optical fiber connected to the ONU 10-1 together. For example, the operator connects the optical fiber 45 and the optical fiber connected to the ONU 10-1 together by fusion.

The operator performs the work illustrated in FIGS. 9(A) and 9(B) for the ONUS 10 connected to the transition source OLT 15 (FIG. 9(C)). FIG. 9(C) illustrates an example in which the work illustrated in FIGS. 9(A) and 9(B) is executed for the ONU 10-1 connected to the transition source OLT 15.

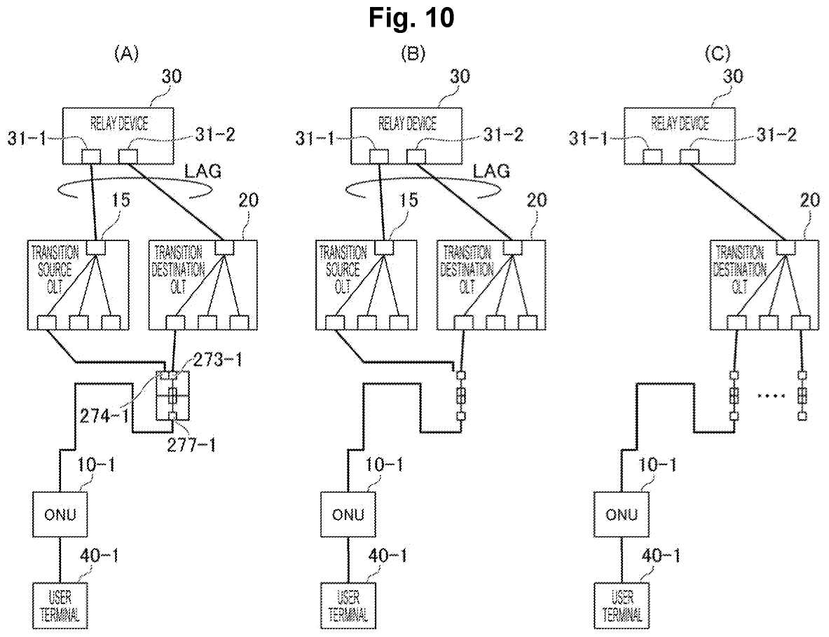

The transition assistance device 27-1 cuts the optical fiber 29 connecting the ONU 10-1 and the transition source OLT 15 to each other in accordance with an instruction from the outside, and moves a movable member 272-1 (FIG. 10(A)). Specifically, first, the transition assistance device 27-1 cuts the optical fiber 29 connecting the ONU 10-1 and the transition source OLT 15 to each other by a cutting unit 278-1. Next, the transition assistance device 27-1 moves the fusion mechanism 276 of the movable member 272-1 to a position of the fusion mechanism 275 of a fixed member 271-1. Then, the transition assistance device 27-1 fuses optical fibers together by the fusion mechanism 275 and the fusion mechanism 276. As a result, the ONU 10-1 and the transition destination OLT 20 are communicably connected to each other via the transition assistance device 27.

The operator removes other than a core line after switching, in the transition assistance device 27-1 (FIG. 10(B)). For example, as illustrated in FIG. 10(B), the operator removes components other than members necessary for connecting the transition destination OLT 20 and the ONU 10 to each other. Thereafter, the operator performs the work illustrated in FIGS. 10(A) to 10(B) for the ONUS 10 connected to the transition assistance device 27 (FIG. 10(C)).

Thereafter, the operator removes the transition source OLT 15 and extra wiring (for example, an optical fiber).

As a result, the transition of the OLT is completed.

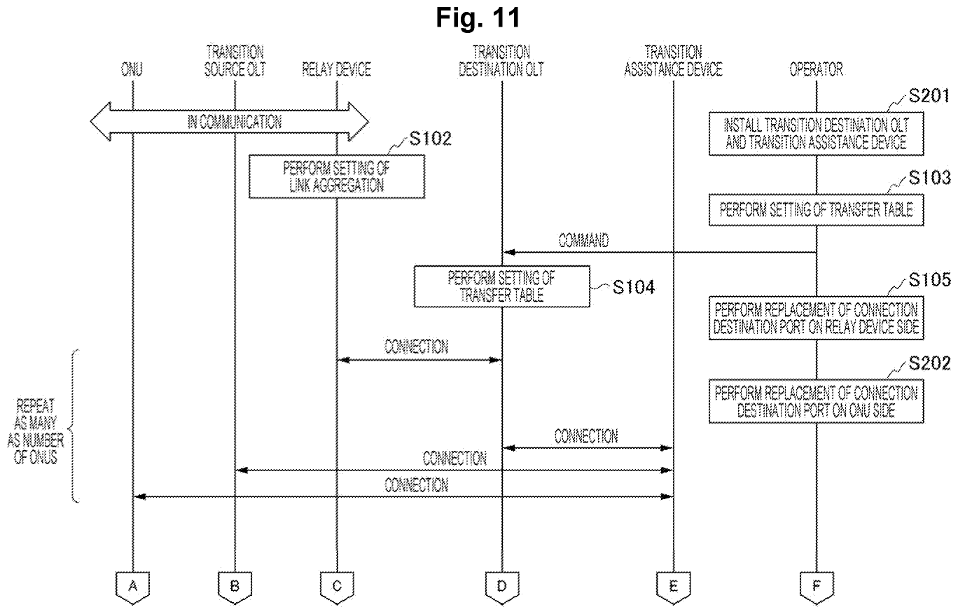

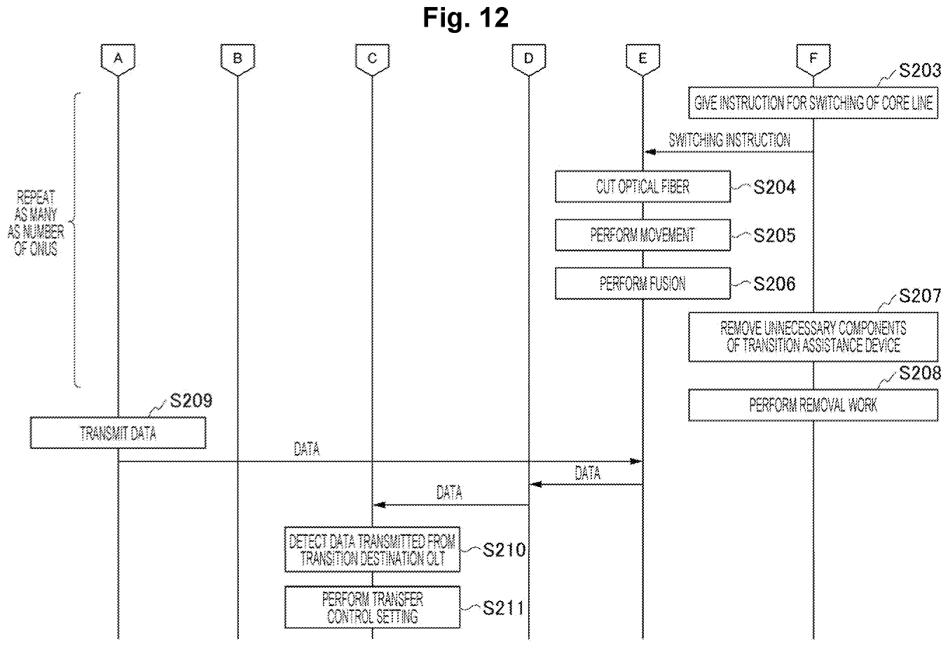

In FIGS. 8 to 10, the outline of the processing at the time of OLT transition has been described. Thus, next, processing of each device at the time of transition will be specifically described with reference to FIGS. 11 to 12. FIGS. 11 and 12 are sequence diagrams illustrating a flow of processing at the time of OLT transition in the optical access system 1. In FIGS. 11 and 12, the same processing steps as those in FIG. 5 is denoted by the same reference numerals as those used in FIG. 5, and explanation thereof is not repeated herein.

At the start of the processing of FIGS. 11 and 12, it is assumed that the ONU 10 and the relay device 30 are in communication with each other via the transition source OLT 15. First, the operator installs the transition destination OLT 20 and the transition assistance device 27 (step S201). As a result, the transition destination OLT 20 and the transition assistance device 27 are installed near the transition source OLT 15. The processing from step S102 to step S105 is executed.

Next, the operator performs replacement of the connection destination port on the ONU 10 side of the transition destination OLT 20 (step S202). Since the specific processing of step S202 is described in FIGS. 9(A) to 9(C), the description thereof is omitted.

The operator executes the processing of step S202 as many as the number of ONUs 10 connected to the transition source OLT 15. As a result, all the ONUs 10 are connected to the transition source OLT 15 and the transition destination OLT 20 via the transition assistance devices 27.

Thereafter, the operator operates the external device to give an instruction for switching of a core line of the transition assistance device 27 (step S203). For example, the operator operates the external device to give an instruction for switching of the transition assistance device 27-1. The external device transmits a switching instruction to the transition assistance device 27-1. The switching instruction includes not only an instruction to cut the optical fiber but also an instruction to move the movable member 272 and to fuse the optical fibers together.

The cutting unit 278-1 of the transition assistance device 27-1 cuts the optical fiber on the basis of the switching instruction transmitted from the external device (step S204). As a result, connection between the ONU 10-1 and the transition source OLT 15 is disconnected. Next, the movement control unit 279 moves the movable member 272 on the basis of the switching instruction transmitted from the external device (step S205). Specifically, the movement control unit 279 moves the movable member 272 to a position where the optical fiber included in the fusion mechanism 276 of the movable member 272 and the optical fiber included in the fusion mechanism 275 of the fixed member 271 can be fused together.

The fusion mechanism 275 and the fusion mechanism 276 fuse the optical fibers together after the movement by the movement control unit 279 is finished (step S206). As an optical fiber fusion method, an existing method is used. As a result, the ONU 10-1 and the transition destination OLT 20 can communicate with each other via the optical fiber. Here, after fusion, the operator confirms connection between the ONU 10-1 and the transition destination OLT 20. Thereafter, if there is no particular problem, the operator removes components other than the core line after switching of the transition assistance device 27-1 (step S207).

With the processing from step S203 to step S207, the ONU 10-1 can transmit and receive data to and from the relay device 30. Specific examples will be described. Uplink data transmission from the ONU 10-1 to the relay device 30 will be described. It is assumed that data addressed to the relay device 30 is transmitted from the ONU 10-1 to the transition assistance device 27-1. The transition assistance device 27-1 is connected to the ONU connection port 211-1 of the transition destination OLT 20 via an optical fiber. For that reason, the data transmitted from the ONU 10-1 is received at the ONU connection port 211-1 of the transition destination OLT 20 via the transition assistance device 27-1. On the basis of the received data and the ONU connection port 211-1 receiving the data, the transition destination OLT 20 refers to the transfer table and determines a transfer destination of the data. For example, in the transfer table included in the transition destination OLT 20, in a case where the destination is the relay device 30 and the reception port is the ONU connection port 211, the transfer destination is set to the relay port 221. Thus, the transition destination OLT 20 transfers the received data to the relay port 221.

The relay port 221 is connected to the relay device 30 via an optical fiber. For that reason, the data output from the relay port 221 is input to the relay device 30. The relay device 30 transfers the received data to a relay device of a network to which a communication device as a destination belongs. As described above, the uplink data transmission from the ONU 10 to the relay device 30 becomes possible.

The operator performs the processing from step S203 to step S207 for the ONUS 10 connected to the transition assistance device 27.

With the above processing, all the ONUS 10 connected to the transition assistance device 27 can communicate with the relay device 30 without passing through the transition source OLT 15. Thereafter, the operator removes the transition source OLT 15 and unnecessary wiring (step S208).

The above description is the description of the processing of transition from the transition source OLT 15 to the transition destination OLT 20, and the processing after the ONU 10 is connected to the transition destination OLT 20 will be further described. The processing from step S209 to step S211 described below is performed by the ONU 10 connected to the transition destination OLT 20 and enabled to communicate.

The ONU 10 transmits data to the transition destination OLT 20 via the transition assistance device 27 (step S209). For example, the ONU 10-1 transmits data to the transition destination OLT 20 via the transition assistance device 27-1.

The transition destination OLT 20 receives the data transmitted from the ONU 10-1 at the ONU connection port 211-1 via the transition assistance device 27. On the basis of the received data and the ONU connection port 211 receiving the data, the transition destination OLT 20 refers to the transfer table and determines a transfer destination of the data. For example, in the transfer table included in the transition destination OLT 20, in a case where the destination is the relay device 30 and the reception port is the ONU connection port 211, the transfer destination is set to the relay port 221. Thus, the transition destination OLT 20 transfers the received data to the relay port 221.

The relay port 221 is connected to the relay device 30 via an optical fiber. For that reason, the data output from the relay port 221 is input to the relay device 30. The relay device 30 transfers the received data to a relay device of a network to which a communication device as a destination belongs. As described above, the uplink data transmission from the ONU 10 to the relay device 30 becomes possible.

The relay device 30 receives the data transmitted from the transition destination OLT 20 by the OLT side transfer unit 3. The detection unit 34 detects that the data received by the OLT side transfer unit 3 is the data transmitted from the transition destination OLT 20 (step S210). The detection unit 34 notifies the transfer control unit 35 that the data transmitted from the transition destination OLT 20 is detected. Upon receiving the notification from the detection unit 34, the transfer control unit 35 acquires information of the ONU 10 that is the transmission source of the data transmitted from the transition destination OLT 20. The information of the ONU 10 that is the transmission source may be, for example, identification information (MAC address or the like) of the ONU 10. The transfer control unit 35 performs transfer setting on the basis of the acquired information of the ONU 10 (step S211). For example, it is assumed that the transfer control unit 35 acquires information for identifying the ONU 10-1.

In this case, the transfer control unit 35 transfers the data addressed to the ONU 10-1 to the transition destination OLT 20. For example, the transfer control unit 35 updates information of a table used for transfer, and sets the transfer destination with the destination of “ONU 10-1” as “OLT connection port 31-2” to which the transition destination OLT 20 is connected. As a result, in a case where the data addressed to the ONU 10-1 is received in the relay device 30 in the subsequent processing, the data is transferred to the transition destination OLT 20 instead of the transition source OLT 15.

According to the optical access system la configured as described above, effects similar to those of the first embodiment can be obtained.

Further, also in the optical access system 1a, since the connection work step has a physical configuration, local work is required, but since an instruction from the outside can be given remotely to the transition assistance device 27, cooperation between a local worker and a remote worker becomes unnecessary, and work can be efficiently performed at a timing of the remote worker.

Further, in the optical access system 1a, by linking a switching timing (operation timing) of the transition assistance device 27 with traffic monitoring in the transition source OLT 15, switching can be performed when high priority traffic does not flow, and improvement in the service quality can be expected.

Modifications common to the first embodiment and the second embodiment will be described.

Switching of the ONUs 10 may be performed in any order.

In the present invention, the link aggregation connection is not essential, and in a case where the link aggregation connection is not performed, setting of transfer to the higher-level device may be performed for a new port for connecting the transition destination OLT 20 to the relay device 30.

Some functions of the transition destination OLT 20, some functions (for example, cutting processing by the cutting unit 278, movement control by the movement control unit 279, and fusion processing by the fusion mechanisms 275 and 276) of the transition assistance device 27, and some functions of the relay device 30 (the link aggregation setting unit 33, the detection unit 34, and the transfer control unit 35) in the embodiment described above may be implemented by a computer. In that case, a program for implementing these functions may be recorded in a computer-readable recording medium, and the program recorded in the recording medium may be read and executed by a computer system to implement the functions. Note that the “computer system” mentioned herein includes an OS and hardware such as a peripheral device. Also, the “computer-readable recording medium” refers to a portable medium such as a flexible disk, a magneto-optical disk, a ROM, or a CD-ROM, or a storage device such as a hard disk included in the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside the computer system serving as a server or a client in that case. Also, the above program may be for implementing some of the functions described above, may be formed with a combination of the functions described above and a program already recorded in the computer system, or may be formed with a programmable logic device such as an FPGA.

Although the embodiment of the present invention has been described in detail with reference to the drawings so far, the specific configuration is not limited to this embodiment, and includes a design and the like without departing from the scope of the present invention.

### INDUSTRIAL APPLICABILITY

The present invention can be applied to a technology associated with transition of an optical communication device.

### REFERENCE SIGNS LIST

10-1 to 10-L ONU
15 transition source OLT
20 transition destination OLT
30 relay device
21-1 to 21-N subscriber side transfer unit
31 OLT connection port
32 Control unit
33 link aggregation setting unit
34 detection unit
35 transfer control unit
211 ONU connection port
221 relay port
222 relay device transfer port
278 cutting unit

1. A higher-level device in an optical access system including: the higher-level device; a transition source subscriber line terminal station device before device replacement, the transition source subscriber line terminal station device communicating with the higher-level device and one or more subscriber line terminal devices; and a transition destination subscriber line terminal station device that is a device replacement destination,
the higher-level device comprising
a transfer control unit that transfers, in a case where data transmitted from the transition destination subscriber line terminal station device is received at a time of device replacement, to the transition destination subscriber line terminal station device, data addressed to one of the subscriber line terminal devices that is a transmission source of the data transmitted from the transition destination subscriber line terminal station device.

2. The higher-level device according to claim 1, wherein the transfer control unit updates information of a transfer table in a case where data transmitted by one of the subscriber line terminal devices whose connection has been switched to the transition destination subscriber line terminal station device is transmitted from the transition destination subscriber line terminal station device, and, when data addressed to the one of the subscriber line terminal devices whose connection has been switched is received, refers to the transfer table and transfers the data to the transition destination subscriber line terminal station device.

3. The higher-level device according to claim 1, wherein the higher-level device performs link aggregation connection with the transition source subscriber line terminal station device before switching, and connects to the transition destination subscriber line terminal station device at some ports where the link aggregation connection is performed.

4. An optical access system comprising:
a higher-level device; a transition source subscriber line terminal station device before device replacement, the transition source subscriber line terminal station device communicating with the higher-level device and one or more subscriber line terminal devices; and a transition destination subscriber line terminal station device that is a device replacement destination, wherein
the transition destination subscriber line terminal station device includes:
a higher-level port for connecting to the higher-level device;
subscriber side connection ports for connecting to the one or more subscriber line terminal devices; and
a transfer control unit that receives data transmitted from the subscriber line terminal devices at the subscriber side connection ports and transfers the data received to the higher-level device via the higher-level port, and
the higher-level device includes
a transfer control unit that transfers, in a case where data transmitted from the transition destination subscriber line terminal station device is received at a time of device replacement, to the transition destination subscriber line terminal station device, data addressed to one of the subscriber line terminal devices that is a transmission source of the data transmitted from the transition destination subscriber line terminal station device.

5. The optical access system according to claim 3, further comprising a transition assistance device that assists device replacement between the transition destination subscriber line terminal station device and the one or more subscriber line terminal devices, wherein
the transition assistance device includes:
a first member, and a second member that is movable, wherein
the first member includes a first port for connecting to the transition source subscriber line terminal station device, and a second port for connecting to the transition destination subscriber line terminal station device,
the second member includes a third port for connecting to the one or more subscriber line terminal devices connected to the transition source subscriber line terminal station device, and
at a start of the device replacement, the transition assistance device is not connected to the transition destination subscriber line terminal station device via the second port, and the first port and the third port are connected to each other via a connection line;
a cutting unit that cuts the connection line connecting the first port and the third port to each other after the transition assistance device is connected to the transition destination subscriber line terminal station device via the second port;
a movement control unit that moves the second member after the connection line is cut by the cutting unit; and
a connection unit that connects the second port and the third port to each other with connection lines after movement of the second member.

6. A transfer method performed by a higher-level device in an optical access system including: the higher-level device; a transition source subscriber line terminal station device before device replacement, the transition source subscriber line terminal station device communicating with the higher-level device and one or more subscriber line terminal devices; and a transition destination subscriber line terminal station device that is a device replacement destination, the transfer method comprising
transferring, in a case where data transmitted from the transition destination subscriber line terminal station device is received at a time of device replacement, to the transition destination subscriber line terminal station device, data addressed to one of the subscriber line terminal devices that is a transmission source of the data transmitted from the transition destination subscriber line terminal station device.

7. (canceled)
